(19) United States
(12) Patent Application Publication
(10) Pub. No.: US 2004/0217198 A1
(43) Pub. Date: Nov. 4, 2004

(54) Portable airbrush

(76) Inventor: Lisa Lloyd, Tucson, AZ (US)

Correspondence Address: Steven Thrasher, 391 Sandhill Dr., Richardson, TX, 75080, US

(21) Appl. No.: 10/326,560

(22) Filed: Dec. 20, 2002

(51) Int. Cl. A62C 13/62

(52) U.S. Cl. 239/306

(57) ABSTRACT

The invention provides a new paint sprayer system and apparatus. In general, the sprayer system includes a cartridge holder for holding a cartridge of compressed air, a cartridge activator mechanically coupled to the cartridge holder, a pressure regulator coupled to the cartridge activator, and a passage coupled to the pressure regulator. Additionally, a method of spraying a liquid is disclosed. The method generates a gas-flow by using a paint sprayer system, and then introduces paint into the gas-flow such that an atomized spray is created at the intersection of the gas-flow and the paint.

### CLAIM OF PRIORITY

The invention relates to and claims priority from co-owned U.S. patent application Ser. No. ______, entitle PORTABLE AIRBRUSH, to Lloyd, et al., Filed on Dec. 20, 2001.

### TECHNICAL FIELD OF THE INVENTION

The invention teaches apparatuses that dispense paint, and more particularly, the invention relates to airbrushes.

### STATEMENT OF A PROBLEM ADDRESSED BY THE INVENTION

Paint has long been used to protect and beautify surfaces. For example, homes are painted on the outside with oil based or strong latex based paints to protect the home's exterior and for beautification. Likewise, walls inside the house (such as in a bedroom) are painted with paints of differing formulations for aesthetics for the protection of surfaces of the home. Similarly, other items are frequently painted-such as automobiles, boats, toys, model airplanes and boats, and arts and crafts. Such preferred paint formulations relative to each type of paint application are well known in the art.

No matter the type of paint, persons who paint use painting accessories, such as brushes, rollers and sprayers, to apply the paint. The preferred painting accessory differs from application to application and from person to person. Thus, a variety of painting accessories have been created to address the needs of those applying paint. Rollers, sponges, and other devices are used primarily to apply paint to interior surfaces, for example. In addition, “power painters” are used to quickly apply heavy exterior coats of paint to an exterior surface.

Due to the advantages afforded by power painters, an ever-greater variety of power painters are becoming available. For example, when detailed painting applications are desired, a spray applicator can be used to paint very detailed pictures on an interior or exterior surface. Unfortunately, spray applicators are not without problems. For example, existing sprays are created using either spray paint cans, or an airbrush that comprises a paint container in combination with hoses, metal tubes, and an electrical compressor. The hoses make airbrushes difficult to carry, complicated, and expensive to produce, sell, and use. They are also difficult to work with, and are difficult to maintain (again, primarily because cleaning the hoses is difficult). Additional disadvantages are well known to those of ordinary skill in the art.

### SUMMARY OF THE INVENTION

The invention provides technical advantages as a hoseless airbrush having an entirely self-contained source of compressed air. In general, the invention provides an airbrush sprayer system that includes a cartridge holder for holding a cartridge of compressed air, a cartridge activator mechanically coupled to the cartridge holder, a pressure regulator coupled to the cartridge activator, and a passage coupled to the pressure regulator. The method generates a gas-flow by using a paint sprayer system, and then controllably introduces a liquid into the gas-flow such that paint are lifted into the gas-flow (called atomization).

In one embodiment, to practice a method according to the invention, a gas cartage, such as a CO2 canister, is inserted into the sprayer. The gas (sometimes called “air”), when released from the air cartridge, travels through a sprayer regulator chamber where the compressed air decompresses into a smooth stream of gas. The smooth steam of gas blows paint that is preferably stored in a separate portion of the sprayer. This technique enables the invention to have fewer parts, making it portable, and less expensive to produce and sell. In addition, the sprayer is small, light weight, and easy to work with.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates the sprayer system of the invention, particularly pointing out the features of the invention that are visible from the outside of a constructed sprayer system; and

FIG. 2 shows a side cut-view of the invention, where the cut is a vertical planar cut taken down the center of the sprayer system.

AN EXEMPLARY EMBODIMENT OF A BEST MODE

The invention provides numerous advantages as a small, lightweight, and easy to use paint sprayer. It may create a spray via any of the traditional methods of using air to generate a spray, and sprays most types of paint. It is also very efficient—even a small gas cartridge, such as a CO2 canister, holds enough gas to paint ten sets of finger nails, and then covers an entire 8 12×111 sheet of paper. Accordingly, the invention disclosed herein is a hoseless airbrush having an attachment for directly connecting a self-contained source of compresses air. In addition, the invention provides an airbrush sprayer system that includes a cartridge holder, a cartridge activator mechanically coupled to the cartridge holder, a pressure regulator coupled to the cartridge activator, and a passage coupled to the pressure regulator. Upon reading the present disclosure, in addition to the methods disclosed herein, numerous methods of employing the invention are readily apparent to those of ordinary skill in the art.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in § 112, paragraph 6 of 35 U.S.C., unless used as “means for—functioning—” or “step for—functioning—” in the claims section.

The Exemplary Figures

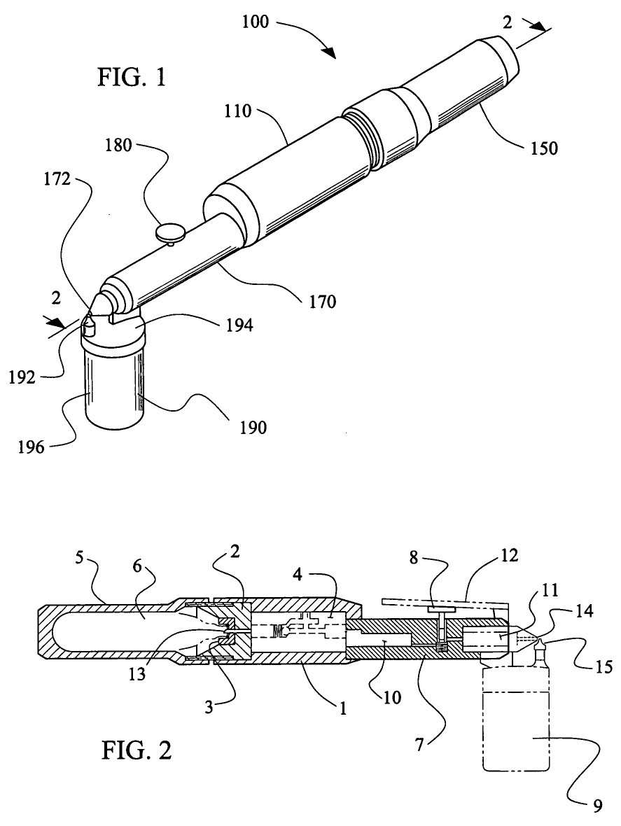

FIG. 1 illustrates a sprayer system according to the teachings of the invention, particularly pointing out the features of the invention that are visible from the outside of the sprayer system. A cartridge holder 150 holds a cartridge of compressed gas, which is preferably carbon dioxide (CO2) gas. The cartridge holder 150 is mechanically coupled to a cartridge activator 110. In one embodiment, the cartridge holder 150 screws into the cartridge activator 110. Furthermore, the cartridge activator 110 maintains a pressure regulator, as discussed below.

The cartridge activator 110 couples the cartridge holder 150 to a tumble chamber 170. A tumble chamber is a pressure chamber that is built into the sprayer system. A tumble chamber accepts compressed air from a compressed air source, and then stores the air at preferably a predetermined air pressure. Accordingly, when an airflow is needed, the air from the compressed air of the tumble chamber is used. Of course, it should be understood that similar functionality can be obtained with the use of a regulator, as described below, and that a tumble chamber is merely an exemplary, optional structure for providing a controlled airflow. Accordingly, the tumble chamber 170, in one embodiment, has a stem-valve 180 attached thereto. Thus, when the stem-valve 180 is depressed, the sprayer system dispenses compressed gas via a gas-nozzle 172. The intersection of gas from the gas nozzle 172, and paint from a liquid nozzle 192, atomizes the paint that can be directed upon a surface. To hold the paint, a liquid-holding jar 190 is coupled to the tumble chamber 170.

Better understanding of the invention can be gained by examining the inside of the sprayer system. Accordingly, FIG. 2 shows a side cut-view of the invention, where the cut is a vertical planar cut taken down the center of the sprayer system shown in FIG. 1. As previously discussed, the system includes a cartridge holder 5 to hold a cartridge of compressed gas 6. A cartridge activator 1 holds a cartridge activator 3 that is centered with the cartridge of compressed gas 6 via a receiving bushing 2 that sits in the cartridge activator 1. In a preferred embodiment, a puncture tube (or pin) 13 is secured in the receiving bushing 2 so that the puncture tube 13 can penetrate the cartridge of compressed gas 6, and may conduit the gas from the cartridge of compressed gas 6 into a pressure regulator 4. In a preferred embodiment, the puncture tube 13 has an orifice (not shown) of approximately 0.015″ diameter. In another preferred embodiment, the orifice adapted to provide venture action. It should be noted that approximate metric equivalents of measurements provided are anticipated, and within the scope of the invention.

The pressure regulator 4 is preferably an adjustable, in-line regulator that may be pre-set to provide a desired output of gas pressure. In one embodiment, the pressure is between 20 psi and 30 psi, and in a preferred embodiment is between 25 psi and 28 psi. Preferably, the pressure regulator 4 has a small output orifice, which is preferably 0.015″ in diameter. Gas discharge from the pressure regulator 4 is managed by a tumble chamber cavity 10 that is maintained within a tumble chamber 7. A special air-flow effect, called a tumble effect, is achieved in the tumble chamber cavity 10 by controlling discharge flow from the pressure regulator 4 via very small input and output orifices that are preferably eccentrically positioned about the tumble chamber cavity 10. In one preferred embodiment of the invention, the sprayer system or sprayer is implemented without the use of a tumble chamber, and an atomized spray is generated directly from an airflow venting from a regulator.

A stem valve 8, which is preferably hand-actuated, is disposed within the tumble chamber 7. Alternatively, control of the airflow is achieved with the use of a control stem valve that is also hand-actuated, but is coupled directly to the regulator. In one embodiment, a lever arm 12 is provided for facilitating actuation of the stem valve 8. In a front portion of a preferred embodiment, a nozzle insert 11 provides a pressure chamber for containing gas that exits the nozzle insert 11 at a nozzle 14. In addition, a jar 9 for holding a liquid (preferably, paint) is also coupled to the tumble chamber 7. A liquid nozzle 15 places a surface of the liquid into the flow of gas to create an atomized gas-liquid mixture at the intersection of the gas nozzle 14 and the liquid nozzle 15. The atomized gas-liquid mixture may then be directed onto a surface.

To activate the sprayer system, a method of spraying paint is herein provided. First, the sprayer system generates a gas-flow of preferably carbon dioxide gas by using a paint sprayer system (preferably the sprayer system disclosed above). Then, a liquid is controllably introduced into the gas-flow such that the paint is atomized at the intersection of the gas-flow and the paint. In a preferred embodiment, the gas flow is at a regulated pressure of between 25 psi and 28 psi so as to produce a directed spray of atomized paint.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A hoseless sprayer system, comprising:
a cartridge holder for holding a cartridge of compressed air;
a cartridge activator mechanically coupled to the cartridge holder; and
a pressure regulator maintained within the cartridge activator.

2. The system of claim 1 wherein the cartridge of compressed air holds carbon-dioxide gas.

3. The system of claim 1 wherein the cartridge activator further comprises a puncture tube for penetrating the cartridge of compressed air.

4. The system of claim 3 wherein the puncture tube is coupled with a receiving bushing that is centered in the cartridge activator.

5. The system of claim 3 wherein the puncture tube has a 0.015 inch orifice.

6. The system of claim 3 wherein the puncture tube has an orifice that allows a predetermined flow of air to transfer from the cartridge of compressed.

7. The system of claim 1 wherein the pressure regulator in an adjustable in-line regulator.

8. The system of claim 7 wherein the adjustable in-line regulator is set to allow a gas flow of between 20 and 30 psi.

9. The system of claim 7 wherein the adjustable in-line regulator is set to allow a gas flow of between 25 and 28 psi.

10. The system of claim 1 further comprising a stem valve that is capable of hand actuation, the stem valve being coupled to the regulator.

11. The system of claim 1 further comprising ajar for holding a liquid, the jar having a liquid nozzle for transporting a liquid into an airflow.

12. A method of spraying paint, comprising:
generating a gas-flow by using a paint sprayer system; and
controllably introducing a liquid into the gas-flow such that an atomized spray is created at the intersection of the gas-flow and the liquid.

13. The method of claim 12 wherein the gas-flow is generated with an aerosol gas.

14. The method of claim 12 wherein the gas-flow is a flow of carbon-dioxide gas.

15. The method of claim 12 wherein the gas flow is at a regulated pressure of between 25 psi and 28 psi.

16. The method of claim 12 wherein the gas-flow is regulated with a hand actuated stem valve.

17. The method of claim 12 wherein the gas-flow is directed.
